(19) United States
(12) Patent Application Publication
(10) Pub. No.: US 2002/0105412 A1
(43) Pub. Date: Aug. 8, 2002

(54) Pager system

(76) Inventor: Alessandro Carissimo, Sleepy Hollow, NY (US)

Correspondence Address: Philip M. Weiss, Esq., WEISS and WEISS PC, 500 Old Country Road, Suite 305, Garden City, NY, 11530, US

(21) Appl. No.: 09/777,078

(22) Filed: Feb. 5, 2001

(51) Int. Cl. H04Q 7/00

(52) U.S. Cl. 340/7.39

(57) ABSTRACT

The present invention relates to an electronic device that provides paging, a user interface and downloadable software.

### FIELD OF THE INVENTION

The present invention relates to an electronic device that provides paging, a user interface and downloadable software.

### BACKGROUND OF THE INVENTION

Many places, where a patron must wait for seating, use a paging system to notify patrons when a table is available. The pager system provides the facility with the ability to recall patrons when their table is ready. These pager systems are commonly those which vibrate or light up to alert the patron that their table is ready.

U.S. Pat. No. 5,696,500 relates to a system for transmitting messages and multi-media presentations to a multi-media receiver. The system includes a multi-media messaging terminal which has a controller for the preparation and transmission of a multi-media presentation, composed of multi-media files. The multi-media files include user programmed text events, graphic events, audio events and multi-media commands. The controller is coupled to a memory, for storing the user programmed text events, graphics events, audio events, and multi-media commands, and a multi-media interface. The multi-media interface provides an interface to transfer the multi-media files being transferred from the multi-media terminal to a paging system. The paging system encodes multi-media files received with encoder for transmission with transmitter.

U.S. Pat. No. 6,008,739 relates to increasing the size of memory available for storing messages in response to the user reading advertisements in a selective call receiver. The method encourages a user of a Selective Call Receiver (SCR) to read advertisements stored in the SCR. When the user reads an advertisement, additional access to that feature is provided for a predetermined time period. Preferably, the feature is memory space, and each time the user reads an advertisement, the memory space available for storing messages is temporarily increased.

U.S. Pat. No. 6,015,344 relates to a prize redemption system for games. A game is provided on a game apparatus for a player to play in exchange for monetary input and prize credits are credited to the player based on the game. The player can be dispensed a specific prize ticket from the game apparatus or other unit that is redeemable for the selected prize. An operator can adjust prizes and payout percentages of the system to achieve a desired profitability for game apparatuses.

U.S. Pat. No. 6,157,814 relates to a wireless subscriber unit and method for presenting advertisements as a message indicator. A wireless subscriber unit contains an advertisement manager. The advertisement manager is programmed to assign an advertisement icon to a message indicator on the display of the wireless subscriber unit. Assignment of the advertisement icon to the message indicator associated with a message maybe based on a predetermined algorithm in the advertisement manager, or based on a notification received from the wireless communication system.

U.S. Pat. No. 5,999,088 relates to a method and apparatus of providing active entertainment for persons waiting for service in which such persons are provided with an electronic pager assembly for notifying when service is available includes an electronically controllable pager assembly having a controllable screen display which is programmed with information likely to be desirable to a person holding the pager. A set of instructions enabling a person to access the information programmed in the pager assembly is printed on the assembly. The pager notification capability functions regardless of whether the information display is or is not active.

### SUMMARY OF THE INVENTION

The present invention relates an electronic paging device. The electronic device comprises; a receiver(s), a transmitter, and a software programmer. It is an object of the present invention, to further provide a charger with the electronic device. It is an object of the present invention to provide a receiver having modes for paging, advertising and entertainment. Examples of entertainment include, games, videos, e-commerce, general information, movies, music, etc. It is an object of the present invention for the receiver to have a display, which provides entertainment and/or advertising. It is an object of the present invention for the receiver to have a user interface. It is an object of the present invention for the user interface to comprise a keypad or touch panel display.

It is an object of the present invention for the receiver to upload or download software and data to and from the charger. It is an object of the present invention for the receiver to upload or download software and data through conductive contacts. It is an object of the present invention for the receiver to perform a wireless upload or download to the charger, transmitter and/or wireless service provider.

It is an object of the present invention for the transmitter to inform the receiver of queue status. It is an object of the present invention for the transmitter to track the last several pages that were made. It is an object of the present invention for the transmitter to upload or download software through hard media. It is an object of the present invention for the hard media to be a diskette or CD. It is an object of the present invention for the transmitter to upload or download software and data through a telecommunication line. It is an object of the present invention for the transmitter to upload or download software and data through a wireless service provider. It is an object of the present invention for the transmitter to store information relating to how and when the receiver was used.

It is an object of the present invention for a single charger to support many receivers at one time. It is an object of the present invention for the charger to both charge and store software. It is an object of the present invention for the charger to store information relating to how and when the receiver was used. It is an object of the present invention for the charger to upload or download software through hard media. It is an object of the present invention for the hard media to be a diskette or CD. It is an object of the present invention for the charger to upload or download software and data through a telecommunication line. It is an object of the present invention for the charger to upload software and data through a wireless service provider.

It is an object of the present invention to use the device in the restaurant industry or any industry with a customer queue for example, retail stores, hospital waiting rooms, airports, service centers, etc. It is an object of the present invention for the device to provide paging, advertising and entertainment that can be periodically updated for users. In most cases the device of the present invention will be given to waiting patrons to entertain them before they are seated or waited upon. Patrons will be paged directly through the device of the present invention when their tables or their activities are ready.

### BRIEF DESCRIPTION OF THE FIGURES

FIG. 1 is an example of the system of the present invention.

### DETAILED DESCRIPTION OF THE INVENTION

In a preferred embodiment, the parts that make up the pager system 10 of the present invention are:

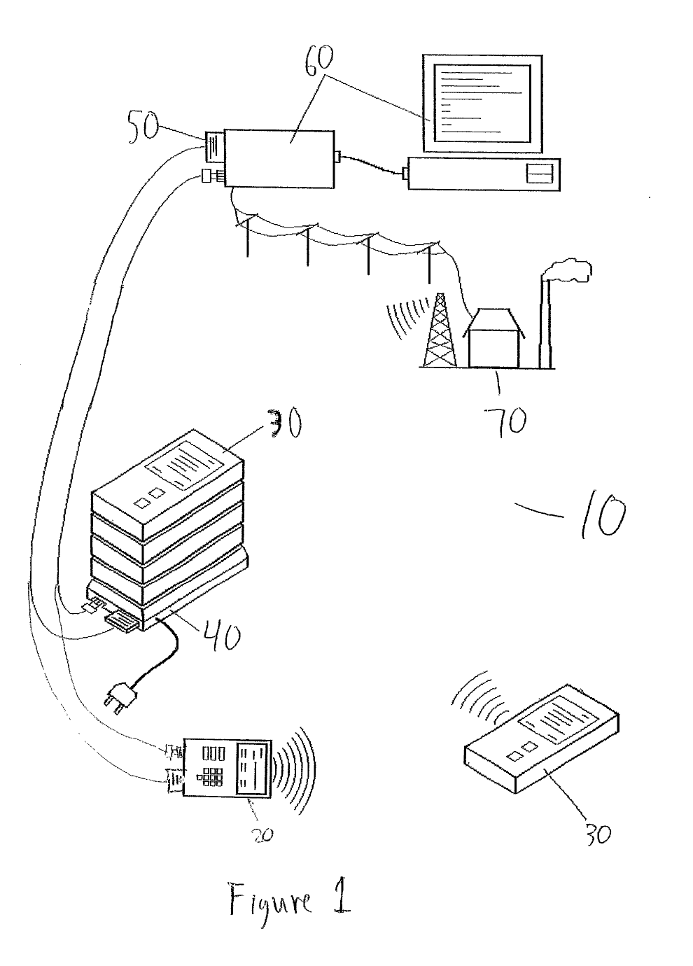

Receiver 30, Transmitter 20, Charger 40 and Cartridge Programmer 60 FIG. 1 shows how these parts interact.

### Receiver

The Receiver 30 is the device the patron carries with him and therefore it is preferred that it be compact. In a preferred embodiment, receiver 30 has the following primary modes: paging, advertising and/or entertainment. Receiver 30 is unique because it has a display to provide entertainment and/or advertising. Users interact with Receiver 30 through a display and keypad or a touch panel display. Receiver 30 is able to upload or download software and data. In one embodiment, Receiver 30 uploads and downloads software when it is placed on charger 40. Conductive contacts between Receivers 30 provide the data transfer interface. Data can be uploaded or downloaded wirelessly to Receiver 30 from Charger 40, Transmitter 20 or a wireless service provider 70. One purpose of downloading to Receiver 30 is to add new advertising, entertainment and general software enhancements. The information communicated to Charger 40 is primarily statistical data defining how and when Receiver 30 was used.

### Transmitter

Transmitter 20, is typically used by a hostess or employee to page Receiver 30 for a particular business. In a preferred embodiment, Transmitter 20 remains stationary. In a preferred embodiment, in addition to paging, Transmitter 20 also tracks the last several pages that were made and lets users know updated information as to where they are in the queue.

The software in the Transmitter 20, including the information that is communicated with Receiver 30, can be installed in at least three different ways.

A Diskette 50 can be inserted into Transmitter 20.

A modem can download software online or directly from another computer.

A wireless network can communicate directly with Transmitter 20.

Transmitter 20 would then perform a wireless data transfer with Receiver 30. New software can be downloaded to Receiver 30 while statistical data and customer inputs can be downloaded to Transmitter 20.

### Charger

The Charger 40 is a storage bay for Receiver 30. In between uses, a Receiver 30 is placed on Charger 40. A single Charger 40 can support many Receivers 30 at one time. Several electrical contacts are made between Receivers 30 and Charger 40 when placed together.

Charger 40 serves two primary purposes, charging and software storage. Charging is done by providing power to several of the contacts that are used to recharge Receiver 30 batteries. Software is stored in Charger 40 memory. After a Receiver 30 has been mounted to a Charger 40 it checks its software version to that stored in the Charger 40. If they vary, the software stored in the charger is down loaded to Receiver 30. In addition, statistical information recorded on the Receiver 30 or input data from the user is downloaded to Charger 40 from Receiver 30.

The software in the Charger 40, including the information that is communicated with Receiver 30, can be installed in at least three different ways.

A Diskette 50 can be inserted into Charger 40.

A modem can download software online or directly from another computer.

A wireless network can communicate directly with Charger 40.

### Software Programmer

The Software Programmer 60 is used to download software to Charger 40, Transmitter 20, or directly to Receiver 30. This is done through a Diskette 50, modem or a wireless network.

The Software Programmer 60 is only used by the manufacturer and not by the restaurants or any other customers.

What is claimed is:

1. An electronic device comprising;
a receiver;
a transmitter; and
a software programmer.

2. The device of claim 1 further comprising a charger.

3. The device of claim 1 wherein said receiver comprises modes of paging, advertising and entertainment.

4. The device of claim 1 wherein said receiver has a display which provides entertainment and/or advertising.

5. The device of claim 1 wherein said receiver has a user interface.

6. The device of claim 5 wherein said user interface comprises a keypad or touch panel display.

7. The device of claim 2 wherein said receiver can upload or download software and data to and from said charger.

8. The device of claim 2 wherein said receiver can upload or download software and data through conductive contacts.

9. The device of claim 2 wherein said receiver can perform a wireless upload or download to said charger, transmitter and/or wireless service provider.

10. The device of claim 1 wherein said receiver can perform a wireless upload or download to said transmitter and/or wireless service provider.

11. The device of claim 1 wherein said transmitter informs said receiver of queue status.

12. The device of claim 1 wherein said transmitter tracks the last several pages that were made.

13. The device of claim 1 wherein said transmitter can upload or download software through hard media.

14. The device of claim 13 wherein said hard media is a diskette or CD.

15. The device of claim 1 wherein said transmitter can upload or download software and data through a telecommunication line.

16. The device of claim 1 wherein said transmitter can upload or download software and data through wireless service provider.

17. The device of claim 1 wherein said transmitter stores information relating to how and when said receiver was used.

18. The device of claim 2 wherein a single charger can support many receivers at one time.

19. The device of claim 2 wherein said charger both charges and stores software.

20. The device of claim 2 wherein said charger stores information relating to how and when said receiver was used.

21. The device of claim 2 wherein said charger can upload or download software through hard media.

22. The device of claim 21, wherein said hard media is a diskette or CD.

23. The device of claim 2 wherein said charger can upload or download software and data through a telecommunication line.

24. The device of claim 2 wherein said charger can upload software and data through wireless service provider.
